(19) United States
(12) Patent Application Publication
(10) Pub. No.: US 2007/0106614 A1
(43) Pub. Date: May 10, 2007

(54) Method and device for making available encoded digital data

(75) Inventor: Adolf Proidl, Vessem (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/579,311

(22) PCT Filed: Nov. 18, 2004
(86) PCT No.: PCT/IB04/52475

§ 371 Date: May 16, 2006

(30) Foreign Application Priority Data
Nov. 20, 2003 (EP) 03104286.4

(51) Int. Cl. G06Q 99/00

(52) U.S. Cl. 705/51; 705/52

(57) ABSTRACT

In a method for preventing unwanted use of encoded digital data (D1, D2; D1′ D2′), provision is made for authorization-to-use information (BBI1, BBI2; BBI1′, BBI2′) to be made available to a data-sink device (3), which authorization-to-use information (BBI1, BBI2; BBI1′, BBI2′) is made available separately from the digital data (D1, D2; D1′D2′), is intended for authorizing use of the digital data (D1, D2; D1′ D2′) by the data-sink device (3) and comprises at least the blocking information (BL1, BL2; BL1′, BL2) for blocking further availability of the digital data (D1, D2; D1′ D2′) plus decoding information (DC1, DC2; DC1′ DC2′), which decoding information (DC1, DC2; DC1′ DC2′) is associated with the digital data (D1, D2; D1′ D2′), is intended for decoding the digital data (D1, D2; D1′ D2′) and is available to the data-source device (4) before the authorization-to-use information (BBI1, BBI2; BBI1′, BBI2′) is made available to the data-sink device (3), and in which method a withdrawal of the availability of the decoding information (DC1, DC2; DC1′ DC2′) to the data-source device (4) also takes place.

The invention relates to a method for preventing unwanted use of digital data, which digital data is available in encoded form, which digital data is made accessible by a data-source device to a data-sink device and which digital data has associated with it blocking information by means of which any making available of the digital data by the data-sink device to a further data-sink device can be blocked.

The invention further relates to a device for preventing unwanted use of digital data, which digital data is available in encoded form, which digital data can be made accessible by a data-source device to a data-sink device and which digital data has associated with it blocking information by means of which any making available of the digital data by the data-sink device to a further data-sink device can be blocked.

The invention further relates to a data-sink device for using digital data, which digital data is available in encoded form, which digital data can be made accessible by a data-source device to a data-sink device and which digital data has associated with it blocking information by means of which any making available of the digital data by the data-sink device to a further data-sink device can be blocked.

The invention further relates to a data-source device for making digital data available to a data-sink device, which digital data is available in encoded form and which digital data has associated with it blocking information by means of which any making available of the digital data by the data-sink device to a further data-sink device can be blocked.

The invention further relates to a combination device having a data-source device of the kind specified in the fourth paragraph above and having a data-sink device of the kind specified in the third paragraph above.

A method of the kind specified in the first paragraph above, a device of the kind specified in the second paragraph above, a data-source device of the kind specified in the third paragraph above, a data-sink device of the kind specified in the fourth paragraph above and a combination device of the kind specified in the fifth paragraph above are known from patent document US 2003/0004885 A1.

This known device or system, which is arranged to perform the known method, is what is termed a “Digital Rights Management system” by means of which digital data can be transferred by a data-source device, which may, for example, be associated with a lender, to a data-sink device, which may, for example, be associated with a borrower, this being done in such a way that no infringement of copyrights in the digital data occurs. For this purpose, the digital data is supplemented, by the owner of the copyright, with authorization-to-use information, thus producing a new digital document. The authorization-to-use information comprises on the one hand lender information and on the other hand borrower information, in which case the lender information represents or specifies the lender of the digital data by whom the digital data is loaned to a borrower, and the borrower information represents the borrower of the digital data who borrows the digital data from the lender. Also provided in the authorization-to-use information is blocking information by means of which any further making available of the digital data by the data-sink device to a further data-sink device can be blocked. After a check on the blocking information relating to the owner of the digital data at the time, which states, for example, whether the lender is in fact entitled to lend the digital information, a digital document that has been newly created in this way is transmitted to the data-sink device of the borrower.

In the case of the known device, the problem exists that the newly created digital document that is loaned to a borrower comprises the authorization-to-use information, which means that access rights and/or rights of use related to persons are contained in the document itself, which provides an opportunity for fraudulent manipulative operations relating to the ownership. There is also the problem that sometimes privacy cannot be maintained if, for example, a third party eavesdrops or listens in electronically on the transmission of a digital document of this kind. In the event that the third party has capabilities that go beyond simply listening-in, he might also be in a position to produce a duplicate of the document and to authorize other persons to access it and to make himself out to be rightful owner. A further problem lies in the fact that a loan of the original digital information—as happens, for example, when an audio recording medium is loaned by one person to another—is not easy to make because, at least in the case of the owner of the copyright, a change always has to be made to the original digital data, which may represent audio information, for example, by supplementing the digital data with the authorization-to-use information, or, in the case of a lender, a change has to be made to the authorization-to-use information that has been combined with the original digital data. A further problem lies in the fact that relatively costly and complicated additional provisions have to be made for the purpose of lending, such as, for example, at the lender's end, relatively costly and complicated hardware and/or software that checks the authorization to lend or reproduce and, where applicable, limits the number of loans and that, when an authorization to lend exists, generates a digital document on the basis of the original digital data or changes an existing digital document, as the case may be. Relatively costly and complicated hardware and/or software that allows a digital document, or rather the digital data contained in a digital document, to be used or, where appropriate, that limits such use in line with the provisos laid down in the authorization-to-use information, also has to be provided at the borrower's end. In both cases, something that has proved to be particularly disadvantageous is therefore that full access has first to be gained to a digital document both at the lender's end and at the borrower's end, which calls for relatively high computing power and relatively large memory resources, before any decisions can be made regarding the rights of access and/or rights of use or utilization.

It is an object of the invention to avoid the problems specified above in a method of the kind specified in the first paragraph above, in a device of the kind specified in the second paragraph above, in a data-sink device of the kind specified in the third paragraph above, in a data-source device of the kind specified in the fourth paragraph above and in a combination device of the kind specified in the fifth paragraph above, and to provide an improved method, an improved device, and improved data-sink device, an improved data-source device and an improved combination device.

To achieve the object specified above, features in accordance with the invention are provided in a method in accordance with the invention, thus enabling a method in accordance with the invention to be characterized in the manner stated below, namely:

A method for preventing unwanted use of digital data, which digital data is available in encoded form, which digital data is made accessible by a data-source device to a data-sink device and which digital data has associated with it blocking information by means of which any making available of the digital data by the data-sink device to a further data-sink device can be blocked, which method comprises the method steps specified below, namely, making available of authorization-to-use information to a data-sink device, which authorization-to-use information is made available separately from the digital data, is intended for authorizing the use of the digital data by the data-sink device and comprises at least the blocking information plus decoding information, which decoding information is associated with the digital data, with which decoding information the digital data can be decoded, and which decoding information is available to the data-source device before the authorization-to-use information is made available to the data-sink device, and withdrawal of the availability of the decoding information to the data-source device.

To achieve the object specified above, features in accordance with the invention are provided in a device in accordance with the invention, thus enabling a device in accordance with the invention to be characterized in the manner stated below, namely:

A device for preventing unwanted use of digital data, which digital data is available in encoded form, which digital data can be made accessible by a data-source device to a data-sink device and which digital data has associated with it blocking information by means of which any making available of the digital data by the data-sink device to a further data-sink device can be blocked, wherein management means are provided, which management means are arranged to make available authorization-to-use information to a data-sink device, which authorization-to-use information exists separately from the digital data, is intended for authorizing the use of the digital data by the data-sink device and comprises at least the blocking information plus decoding information, which decoding information is associated with the digital data, with which decoding information the digital data can be decoded, and which decoding information is available to the data-source device before the authorization-to-use information is available to the data-sink device, and wherein the management means are arranged to withdraw the availability of the decoding information to the data-source device.

To achieve the object specified above, features in accordance with the invention are provided in a data-sink device in accordance with the invention, thus enabling a data-sink device in accordance with the invention to be characterized in the manner stated below, namely:

A data-sink device for using digital data, which digital data is available in encoded form, which digital data can be made accessible by a data-source device to the data-sink device and which digital data has associated with it blocking information by means of which any making available of the digital data by the data-sink device to a further data-sink device can be blocked, wherein first processing means are provided that are arranged to process the digital data by taking account of an enabling signal able to be fed to them, which enabling signal enables the digital data to be processed by the first processing means, and by using decoding information, which decoding information is associated with the digital data and the digital data can be decoded by means thereof, wherein first checking means are provided that are arranged firstly to cooperate with a device as claimed in any of claims 7 to 12, that are arranged secondly to check whether authorization-to-use information is available for the data-sink device, which authorization-to-use information exists separately from the digital data, is intended for authorizing the use of the digital data by the data-sink device, comprises at least the blocking information and the decoding information and is available to the data-source device before it is made available to the data-sink device, and that are arranged thirdly to generate the enabling signal and transmit the enabling signal to the processing means when there is a positive result to the check, and wherein blocking means are provided that, by taking account of the blocking information, are arranged to block any making available of the digital data to a further data-sink device.

To achieve the object specified above, features in accordance with the invention are provided in a data-source device in accordance with the invention, thus enabling a data-source device in accordance with the invention to be characterized in the manner stated below, namely:

A data-source device for making digital data available to a data-sink device, which digital data is available in encoded form and which digital data has associated with it blocking information by means of which any making available of the digital data by the data-sink device to a further data-sink device can be blocked, wherein second processing means are provided that are arranged to process the digital data by taking account of an enabling signal able to be fed to them, which enabling signal enables the digital data to be processed by the second processing means, and by using decoding information, which decoding information is associated with the digital data and the digital data can be decoded by means thereof, and wherein second checking means are provided that are arranged firstly to cooperate with a device as claimed in any of claims 7 to 12, that are arranged secondly to check whether decoding information is available for the data-source device, and that are arranged thirdly to generate the enabling signal and transmit the enabling signal to the second processing means when there is a positive result to the check.

To achieve the object specified above, provision is made in a combination device in accordance with the invention for the combination device to comprise a data-source device in accordance with the invention and a data-sink device in accordance with the invention.

By the making of the provisions in accordance with the invention, the advantage is obtained that digital data can be lent (or hired) by a lender to a borrower in exactly the form in which it originally exists. The advantage is also obtained that, in a manner analogous to what occurs in a simple, ordinary, conventional lending process for material objects, digital data can only ever be used by that user for whom the possibility of using it exists at the time concerned, because it is this user who has received the digital data, in a similar way to a loaned object, from a lender. In the case of digital data, the possibility that the user has of making use of the data is afforded by the making available of the authorization-to-use information to the borrower's data-sink device, in which case the decoding information ceases to be available to the lender's data-source device at the same time. Because of the clear division between the digital data and the authorization-to-use information, the advantage is also obtained that only a relatively small amount of data has to be processed, or made available, or transferred to provide the authorization-to-use information, whereas the amount of data for the digital data itself, which is usually relatively large, does not have to be touched or, where necessary, transferred. This also makes possible central management or storage of the digital data on a server that is available in common to the lender and borrower or to users in general and that they can both access with their respective terminals, such as, for example, the data-source device or the data-sink device or the combination device. This also gives the advantage that the digital data can be distributed on a data carrier or via an on-line service without copyrights in the digital data being infringed by any production of copies of the original digital data, because the copyright will not be affected in that only those persons to whom the decoding information is available will be able to use the digital data. The advantage is also obtained that the decoding information, together with the blocking information, is made available as a unit in the authorization-to-use information, which means that no unauthorized further distribution of the decoding information can take place.

In the solutions in accordance with the invention, provision may, for example, be made for the withdrawal of the availability of the decoding information to the data-source device to take place as a result of a refusal of rights of access to the decoding information. It has however proved particularly advantageous if, in addition, the provisions claimed in claim 2 and claim 8 are made in the respective cases. This gives the advantage that the deletion of the decoding information ensures that the decoding information disappears completely, thus totally ruling out any possibility of the access rights being fraudulently manipulated, which means that under no circumstances whatever is the data-source device able to access the digital data or use it.

In the solutions in accordance with the invention, it has also proved advantageous if, in addition, the provisions claimed in claim 3 and claim 9 are made in the respective cases. This gives the advantage that there is available to the data-source device information characteristic of the data-sink device, by means of which unequivocal proof can be obtained of the whereabouts of the rights to use the digital data and, if required, the rights to use the digital data can be actively requested back from the data-sink device by the data-source device in a targeted manner.

In the solutions in accordance with the invention, it has also proved especially advantageous if, in addition, the provisions claimed in claim 4 and claim 10 are made in the respective cases. This gives the advantage that a personal or professional relationship between users, or a relationship existing on some other basis, can be conveyed by means of the relationship information so that, where, for example, quite a close relationship, such as a friendly relationship say, exists between a user—such as the borrower, for example—and another user—such as the lender, for example, the authorization-to-use information can be made available to the borrower without the lender previously being queried, whereas where there is a more distant relationship between two users the lender first has to give a positive answer to a query of this kind, i.e. the lender has to give his consent for the authorization-to-use information to be made available.

In the solutions in accordance with the invention, it has also proved especially advantageous if, in addition, the provisions claimed in claim 5 and claim 11 are made in the respective cases. This gives the advantage that the right to use the digital data can be unequivocally transferred back to the data-source device.

In the solutions in accordance with the invention, it has also proved advantageous if, in addition, the provisions claimed in claim 6 and claim 12 are made in the respective cases. This gives the advantage that a return of the rights to use the digital data from the present user—such as the borrower, for example—to the preceding user in time—such as the lender, for example—can take place as a function of a relationship between the two users, which means that, where, for example, quite a close relationship exists between the two users, the authorization-to-use information for the borrower can be withdrawn without the lender previously being queried, whereas where there is a more distant relationship between two users the borrower first has to give a positive answer to a query of this kind, i.e. the borrower has to give his consent to the withdrawal of the rights to use the digital data.

In a data-sink device in accordance with the invention, it has also proved advantageous if, in addition, the provisions claimed in claim 14 are made. This means that the advantages that have been specified in connection with the device in accordance with the invention also come into play in the data-sink device in accordance with the invention.

In a data-source device in accordance with the invention, it has also proved advantageous if, in addition, the provisions claimed in claim 16 are made. This means that the advantages that have been specified in connection with the device in accordance with the invention also come into play in the data-source device in accordance with the invention.

It should be mentioned at this point that the advantages that have been specified in connection with the device in accordance with the invention also come into play in the combination device in accordance with the invention.

These and other aspects of the invention are apparent from and will be elucidated with reference to the embodiments described hereinafter, to which however the invention is not limited.

In the drawings:

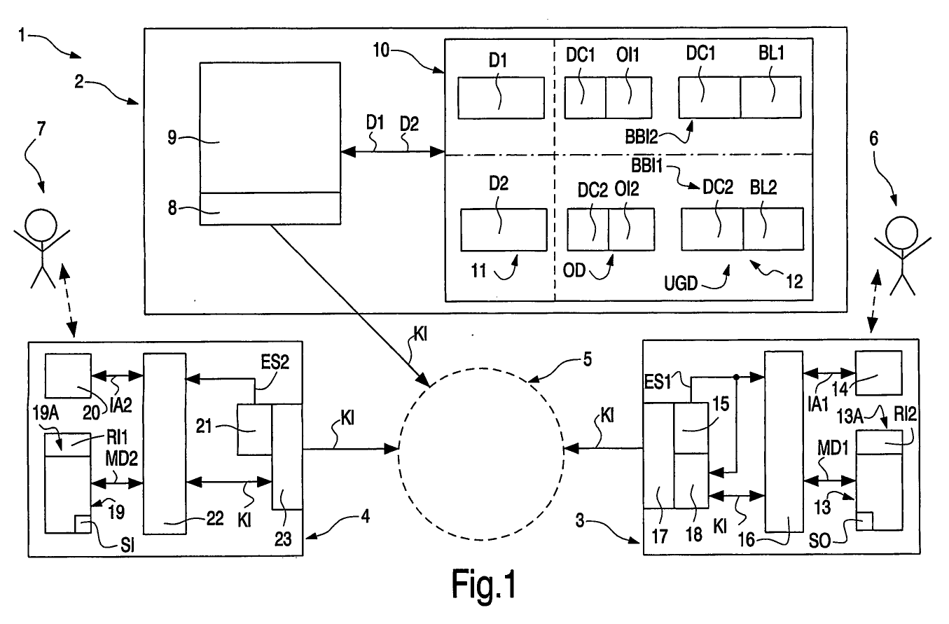

FIG. 1 is a diagrammatic view, in the form of a block circuit diagram, of a communications system for using digital data according to a first embodiment of the invention.

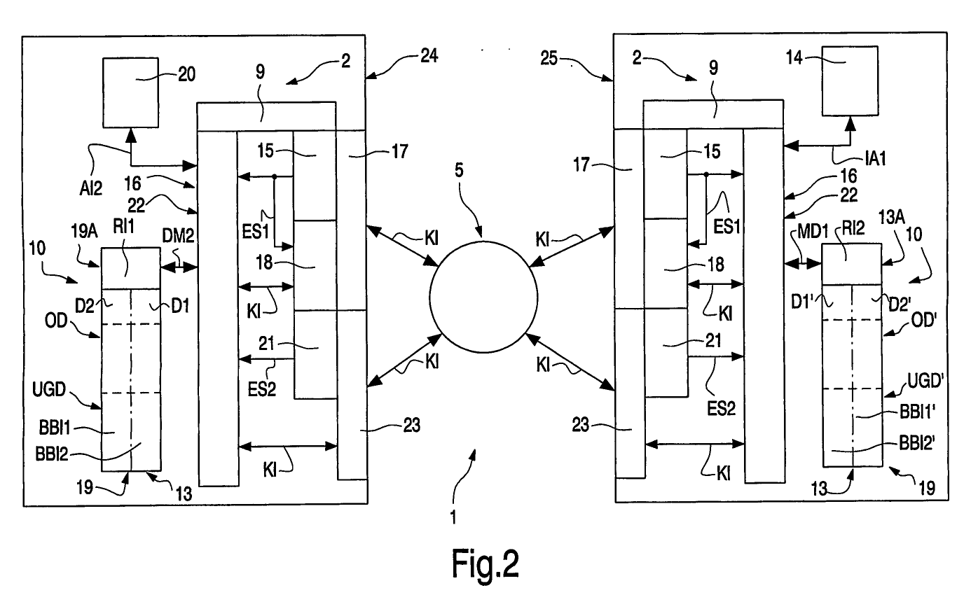

FIG. 2 is a diagrammatic view, in the form of a block circuit diagram, of a communications system for using digital data according to a second embodiment of the invention.

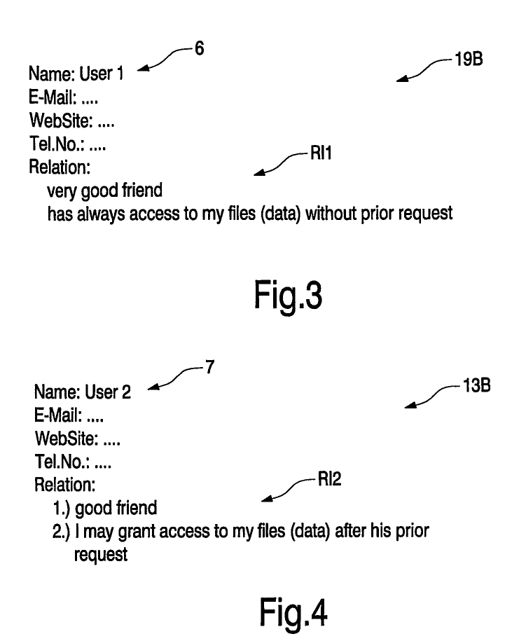

FIG. 3 shows, in plain language, a first address book entry in an electronic address book, relating to a first user of the communications system in accordance with the invention.

FIG. 4 shows, in a similar way to FIG. 3, a second address book entry in an electronic address book, relating to a second user of the communications system in accordance with the invention.

Shown in FIG. 1 is a communications system 1, which communications systems 1 has a device 2 for preventing unwanted use of sets of digital data D1 and D2, a first processing device that is formed by a data-sink device 3 and is arranged to process the sets of digital data D1 and D2, and a second processing device that is formed by a data-source device 4 and is arranged to process the sets of digital data D1 and D2. In the present case, the first processing device and the second processing device are implemented in the form of a television set capable of communicating with the internet. It should be mentioned at this point that the data-sink device 3 and the data-source device 4 may also each be implemented in the form of a so-called digital set-top box that is connected to a conventional television set. Both the device 2 and also the data-sink device 3 and data-source device 4 are arranged to communicate over a computer network 5, such as, for example, the internet or a so-called wide area network (WAN) or a so-called local area network (LAN) or a combination of the types of network just mentioned. In the present case, the sets of digital data D1 and D2 can be made available, with the help of the device 2, by the data-source device 4 to the data-sink device 3, a subject that will be considered in detail below. The data-sink device 3 is clearly identified by data-sink information SO stored in it and the data-source device 4 is clearly identified by data-source information SI stored in it.

Also shown in FIG. 1 is a first user 6 who interacts with the first data-sink device 3. There is further shown in FIG. 1 a second user 7 who interacts with the data-source device 4 and who is the owner of the sets of digital data D1 and D2.

The device 2 has first communications means 8, management means 9 and first storage means 10. The first communications means 8 are arranged to communicate with the two processing devices 3 and 4 and to cooperate with the management means 9. The first storage means 10 have a data storage region 11 that is arranged and intended to store the first set of data D1 and the second set of data D2. The first storage means 10 also have a management storage region 12 that is divided in turn into a first storage sub-region for storing owner data OD and a second storage sub-region for storing authorization-to-use data UGD.

The owner data OD is intended to represent first decoding information DC1, that corresponds to the first set of data D1 and is intended for the decoding of the first set of data D1, and first owner information OI1 that is intended to specify the second user 7 as the owner of the first set of data D1. The owner data OD is also intended to represent second decoding information DC2, that corresponds to the second set of data D2 and is intended for the decoding of the second set of data D2, and second owner information OI2 that is intended the specify the second user 7 as the owner of the second set of data D2.

The authorization-to-use data UGD is intended to represent first authorization-to-use information BBI1 corresponding to the first set of data D1 and second authorization-to-use information BBI2 corresponding to the second set of data D2. The sets of authorization-to-use information BBI1 and BBI2 are intended for authorized use of the sets of digital data D1 and D2 respectively by the data-sink device 3 and they comprise at least respective sets of blocking information BL1 and BL2 and their respective sets of decoding information DC1 and DC2. The first decoding information DC1 is associated with the set of digital data D1 and is available to the data-source device 4 before the first decoding information DC1 is available to the data-sink device 3, i.e. is used for the first authorization-to-use information BBI1. The second decoding information DC2 is associated with the set of digital data D2 and is available to the data-source device 4 before the second decoding information DC2 is available to the data-sink device 3, i.e. is used for the second authorization-to-use information BBI2.

The management means 9 are arranged to make available the authorization-to-use information BBI1 or BBI2 to the data-sink device 3, which sets of information exist separately from the respective sets of digital data D1 and D2.

For this purpose, the particular authorization-to-use information BBI1 or BBI2 is generated by means of the management means 9 in response to a request by the data-source device 4, or in response to a query by the data-sink device 3 and, where appropriate, once permission has been given by the data-source device 4, and it is stored in the management storage region 12 with the help of the authorization-to-use data UGD. When this is done, the decoding information DC1 or DC2 is taken, i.e. copied, from the owner data OD and is used to generate the particular authorization-to-use information BBI1 or BBI2.

The management means 9 are also arranged to withdraw the availability of the decoding information DC1 or DC2 to the data-source device 3, the management means 9 being arranged, in actual physical terms, to delete the particular decoding information DC1 or DC2, which decoding information DC1 or DC2 previously served to generate the particular authorization-to-use information BBI1 or BBI2. The management means 9 are also arranged to take note of the data-sink information SO for the data-sink device 3 to which the particular set of data D1 or D2 is being made accessible, the data-sink information SO being stored, in combination with the particular owner information OI1 or OI2, by means of the owner data OD in place of the previously deleted decoding information DC1 or DC2.

It should be mentioned that the data-sink information SO to be noted may also be stored elsewhere than in the first region of the storage means 10, from which first region the particular decoding information DC1 or DC2 has previously been deleted.

The management means 9 are further arranged to supplement the particular authorization-to-use information BBI1 or BBI2 with the data-sink information SO for the data-sink to which the particular set of data D1 or D2 is being made accessible. The data-sink information SO forms, in this case, the blocking information BL1 or BL2 by means of which passing on of the respective set of digital data D1 or D2 to a data-sink device other than the one to which the particular set of data D1 or D2 was made accessible can be blocked.

The management means 9 are in addition arranged to take account of first relationship information RI1 that is stored in an electronic address book in the data-source device 4 and by means of which the relationship of the second user 7, of the data-source device 4, to the first user 6, of the data-sink device 3, is defined. For this purpose, the management means 9 are arranged, as a function of the relationship defined by the first relationship information RI1, to enable the authorization-to-use information BBI1 or BBI2 to be made available to the data-sink device 3, and to enable the availability of the decoding information DC1 or DC2 to the data-source device 4 to be withdrawn, either only at the instigation of the second user 7, of the data-source device 4—i.e. the owner or lender of the sets of digital data D1 or D2—or also at the instigation of the first user 6, of the data-sink device 3—i.e. the borrower of the sets of digital data D1 or D2. In the present case the first relationship information RI1 shown in FIG. 3 specifies that the first user 6 can use the set of data D1 or D2 on request, that is to say without the second user 7 actually assenting to the request every time, because it is shown by means of the first relationship information RI1 that the first user 6 is considered by the second user 7 to be a very good friend who can borrow the sets of digital data D1 and D2 on his own initiative.

The management means 9 are further arranged to enable the availability of the set of digital data D1 or D2 to the data-sink device 3 to be terminated, the management means 9 being arranged to make available to the data-source device 4 the decoding information DC1 or DC2 previously made available to the data-sink device 3 and to withdraw the availability to the data-sink device 3 of the decoding information DC1 or DC2. The management means 9 are arranged in this case to take, from the particular authorization-to-use information BBI1 or BBI2, the decoding information DC1 or DC2 that was previously used to form this authorization-to-use information BBI1 or BBI2, and to store the particular decoding information DC1 or DC2 at the position originally intended for it in the owner data OD, the data-sink information SO stored at this position being overwritten. The management means 9 are further arranged to delete the particular authorization-to-use information BBI1 or BBI2 that previously served as a source for the decoding information DC1 or DC2.

The management means 9 are further arranged to take account of second relationship information RI2, shown in FIG. 4, that is stored in an electronic address book in the data-sink device 3 and by means of which the relationship of the first user 6 to the second user 7 can be defined. For this purpose, the management means 9 are arranged, as a function of the relationship defined by the second relationship information RI2, to enable the availability of the set of digital data D1 or D2 to the data-sink device 3 to be terminated either only at the instigation of the first user 6, of the data-sink device 3—i.e. the borrower—or also at the instigation of the second user 7, of the data-source device 4—i.e. the rightful owner. What is achieved in this way is that the original owner of the set of digital data D1 or D2, namely the second user 7, can, on his own initiative and above all without having to ask the first user 6, withdraw the authorization to use the set of digital data D1 or D2 that was granted to the first user 6 by way of loan.

For the purposes of processing the sets of digital data D1 and D2, the data-sink device 3 has second storage means 13, first interaction means 14, first checking means 15, first processing means 16, second communications means 17 and first blocking means 18.

The second communications means 17 are arranged to communicate with the device 2, in which case communication information K1 can be exchanged between the device 2 and the first processing device 3. The first interaction means 14 are arranged to make tactile or audio/visual interaction possible with the first user 6 and for this purpose to exchange interaction information IA1, representing the interaction, with the first processing means 16, by means of which interaction information IA1 the processing means 16 can be controlled or information, which may be represented by the set of digital data D1 or D2 for example, can be made accessible to the user 6.

The first processing means 16 are further arranged to process the set of digital data D1 or D2, so doing by taking account of a first enabling signal ES1 that is able to be fed to them, which first enabling signal ES1 enables the set of digital data D1 or D2 to be processed by the first processing means 16, and by using the decoding information DC1 or DC2 in the respective cases. The first processing means 16 are further arranged to exchange first memory data MD1 with the first storage means 8, which first memory data MD1 may possibly arise when the set of digital data D1 or D2 is processed.

The first checking means 15 are arranged to cooperate with the device 2, by making use of the second communications means 17, in order to check whether authorization-to-use information BBI1 or BBI2 is available for the data-sink device 3. A check is made in this case with the help of the second communications means 17 to see whether authorization-to-use information BBI1 or BBI2 in which the particular blocking information BL1 or BL2 is given by the data-sink information SO that is stored in the second storage means 13 is present in the device 2. If the check gives a positive result, the first checking means 15 are also arranged to generate the first enabling signal ES1 and transmit the first enabling signal ES1 to the first processing means 16.

The first blocking means 18 are arranged, by taking account of the blocking information BL1 or BL2, to block any making available of the sets of digital data D1 or D2 to a further data-sink device, which is not however shown in FIG. 1. This ensures that neither the sets of digital data D1 and D2 themselves, which are processed as a whole or in the form of a data stream, nor the particular authorization-to-use information BBI1 or BBI2 that is available to the data-sink device 3 can be passed on or can be used by another data-sink device cooperating with the data-sink device 3.

The second storage means 13 have a first address-book storage region 13A that is intended to store the second address-book entry 13B shown in FIG. 4. As well as one entry each for the name, the telephone number, the e-mail address and the web site of the second user 7, the second address book entry 13B also has an entry relating to the relationship of the first user 6 to the second user 7, which relationship is represented by the second relationship information RI2.

The data-source device 4 is arranged to make available the set of digital data D1 or D2 to the data-sink device 3, which it does in the present case by loading the sets of digital data D1 and D2 onto the device 2 and by associating the owner data OD with the set of digital data D1 or D2 as the case may be, a process that is performed at the device 2.

The data-source device 4 has third storage means 19, second interaction means 20, second checking means 21, second processing means 22 and third communications means 23.

The third communications means 23 are arranged to communicate with the device 2, in which case communication information K1 can be exchanged with the device 2. The second interaction means 20 are arranged in a substantially similar way to the first interaction means 14 and serve the same purpose, second interaction information IA2, by means of which an effect can be achieved similar to that achieved with the interaction information IA1, being interchangeable between the second interaction means 20 and the second processing means 22. The second processing means 22 are arranged to process the set of digital data D1 or D2, so doing by taking account of a second enabling signal ES2 that is able to be fed to them, which second enabling signal ES2 enables the sets of digital data D1 and D2 to be processed by the second processing means 22, and by using the decoding information DC1 or DC2.

The second checking means 21 are arranged to cooperate with the device 2 with the help of the third communications means 23, in order to check whether either of the sets of decoding information DC1 or DC2 for the data-source device 4 is available in the owner data OD in the device 2. A check is made in this case to see whether there is, in the device 2, decoding information DC1 or DC2 that has associated with it in the owner data OD, as the owner information OI1 or OI2, the data-source information SI that is stored in the third storage means 19. If the check gives a positive result, the second checking means 16 are also arranged to generate the second enabling signal ES2 and transmit the second enabling signal ES2 to the second processing means 22, thus enabling that set of digital data D1 or D2 for which the particular decoding information DC1 or DC2 is available to the data-source device 4 to be processed.

The third storage means 19 have a second address-book storage region 19A that is intended to store the first address-book entry 19B shown in FIG. 3. As well as one entry each for the name, the telephone number, the e-mail address and the web site of the first user 6, the first address book entry 19B also has an entry relating to the relationship of the second user 7 to the first user 6, which relationship is represented by the first relationship information RI1.

What is said above shows that a method for preventing unwanted use of the sets of digital data D1 and D2 can be performed with the help of the device 2. In the method, one of the items of authorization-to-use information BBI1 or BBI2 is first made available to the data-sink device 3, which means that the particular authorization-to-use information BBI1 or BBI2 is available separately from the sets of digital data D1 and D2. As a function of the first relationship information RI1 stored in the data-source device 4, the authorization-to-use information BBI1 or BBI2 is made available in this case either only by the second user 7, of the data-source device 4, or by the first user 6, of the data-sink device 3, as well. In the present case, it is specified by means of the first relationship information RI1 stored in the data-source device 4 that the making available of the particular authorization-to-use information BBI1 or BBI2 can also be instigated by the first user 6, of the data-sink device 3.

What actually happens is that a query is received in the device 2 from the data-sink device 3 with the help of the communications information K1 and, by consulting the relationship information RI1 stored in the data-source device 4, a check is made on whether the authorization-to-use information BBI1 or BBI2 can be made available to the data-sink device 3 with or without the explicit consent of the second user 7. In the present case, explicit consent by the second user 7 is not required, and a copy of the particular decoding information DC1 or DC2 in the authorization-to-use data UGD corresponding to the particular set of digital data D1 or D2 is therefore generated by means of the management means 9. The decoding information DC1 or DC2 that was used as a basis for the copy is then deleted and the data-sink information SO able to be received or interrogated by the data-sink device 3 is stored in the owner data OD at the point from which the particular decoding information DC1 or DC2 was deleted. Also, the data-sink information SO is stored in combination with the copied decoding information DC1 or DC2 and, together with the latter, forms the particular authorization-to-use information BBI1 or BBI2, it being ensured that the first authorization-to-use information BBI1 corresponds to the first set of digital data D1 and the second authorization-to-use information BBI2 corresponds to the second set of digital data D2.

The deletion of the decoding information DC1 or DC2 previously available to the data-source device 4 causes the particular decoding information DC1 or DC2 to be withdrawn from the data-source device 4. As a result of the storage of the data-sink information SO in place of the previously deleted decoding information DC1 or DC2, a note is made in the owner data OD of the data-sink device 3 to which the authorization to use the set of digital data D1 or D2 was granted by way of loan, thus enabling unequivocal evidence to be obtained with the help of the owner data OD on the one hand of the whereabouts of the authorization to use and on the other hand of the ownership of the rights of use.

What can also be effected with the help of the method for preventing unwanted use of digital data is a termination of the making available of the sets of digital data D1 or D2 to the data-sink device 3. What happens in this case is that the decoding information DC1 or DC2 that was previously made available to the data-sink device 3 is firstly made available to the data-source device 4. This is done by taking, i.e. copying, the decoding information DC1 or DC2 contained in the particular authorization-to-use information BBI1 or BBI2 and storing the copy of this decoding information DC1 or DC2 in the owner data OD at that point at which the data-sink information SO is stored in the owner data OD, which data-sink information SO states to which data-sink device 3 the authorization to use the set of digital data D1 or D2 was granted. The availability of the decoding information DC1 or DC2 to the data-sink device 3 is withdrawn at the same time, the corresponding authorization-to-use information BBI1 or BBI2 being deleted in the authorization-to-use data UGD.

When the making available of the set of digital data D1 or D2 to the data-sink device 3 is terminated, this termination too takes place as a function of the second relationship information RI2 stored in the data-sink device 3. In the present case, the second relationship information RI2 specifies that a return of the authorization to use the particular set of digital data D1 or D2 to the owner, i.e. to the second user 7, can take place only at the instigation of the first user 6. What this means is that an enquiry, relating to the return of the authorization-to-use by the first user 6 to the second user 7 who is the original owner of the set of digital data D1 or D2, that is received at the device 2 from the data-source device 4 with the help of the communications information K1 is passed on to the data-sink device 3. A positive answer then has to be given by the first user 6, with the help of the communications information K1 that can be communicated from the data-sink device 3 to the device 2, to this enquiry by the second user 7, before the management means 9 terminate the making available of the set of digital data D1 or D2 to the data-sink device 3. It should be mentioned at this point that the second relationship information RI2 may also state that the second user 7 may summarily instigate the termination of the making available of the set of digital data D1 or D2, that is to say without the first user 6 having to consent to this. This has the advantage that, as the owner of the set of digital data D1 and D2, the second user 7 is able to actively transfer the rights to use the set of digital data D1 and D2 back to himself.

With regard to the making available of the set of digital data D1 or D2, it should be mentioned that, as was described above by reference to FIG. 1, this can be done by storing the decoding information DC1 and DC2 and the authorization-to-use information BBI1 and BBI2 centrally by means of the device 2, although this presupposes that the device 2, the data-source device 4 and the data-sink device 3 are able to communicate with one another virtually permanently. However, when an authorization to use is being granted to the data-sink device 3, i.e. to the first user 6, provision may also be made for the particular authorization-to-use information BBI1 or BBI2 to be transmitted to the data-sink device 3. However, it must be ensured in this connection that, in the event of the authorization to use being withdrawn, the authorization-to-use information BBI1 or BBI2 is deleted at the data-sink device 3, which can, for example, be done as a result of the first checking means 15 cooperating with the first processing means 16.

Depicted in the communications system 1 shown in FIG. 2 are a first combination device 24 and a second combination device 25.

The first combination device 24 has the data-source device 4 shown in FIG. 1, the data-sink device 3 shown in FIG. 1, and the device 2 shown in FIG. 1, for preventing unwanted use of the sets of digital data D1 and D2 that are stored in the first combination device 24.

The second combination device 25 likewise has the data-source device 4 shown in FIG. 1, the data-sink device 3 shown in FIG. 1, and the device 2 shown in FIG. 1, for preventing unwanted use of the sets of digital data D1′ and D2′ that are stored in the second combination device 24.

In the present case, the combinations of the data-sink device 3 and the data-source device 4 form components of networkable video recorders. It should be mentioned at this point that the combination devices 24 and 25 may also be formed by audio recording and/or reproducing devices such as, for example, so-called MP3 players.

What is achieved by integrating the data-source device 4 and the data-sink device 3 in the first combination device 24 and the second combination device 25 is that the combination devices 24 and 25 can each be operated both as data sources for making available the sets of digital data D1, D2 and D1′, D2′ respectively stored in them and as data sinks for using the respective sets of digital data D1, D2 and D1′, D2′. The first combination device 24 therefore has data-source information SI intended for unequivocal identification and data-sink information SO, although these are not explicitly shown in FIG. 2. The same is true of the second combination device 25.

By integrating the device 2 in each of the two combination devices 24 and 25, what is also achieved is that the prevention of unwanted use of the respective sets of digital D1, D2 and D1′, D2′ stored in the combination devices 24 and 25 is obtained reliably and in a self-contained fashion without a server being needed to supply the sets of digital data D1, D2 and D1′, D2′, which server is implemented in FIG. 1 in the form of the device 2.

In the present case too, provision is made for the respective sets of authorization-to-use information BBI1, BBI2 and BBI1′, BBI2′ able to be generated in the combination devices 24 and 25 to be stored in the respective storage means 10 of the devices 2 in the combination devices 24 and 25 and to be managed by the management means. For the granting of the particular authorization to use, provision may however also be made for the authorization-to-use information BBI1 or BBI2 to be transmitted to the combination device 25 and for the authorization-to-use information BBI1′ or BBI2′ to be transmitted to the combination device 24. In this case too, steps must be taken to ensure that, in the event of the particular authorization to use being withdrawn, the authorization-to-use information BBI1 or BBI2, or BBI1′ or BBI2′ that was previously transmitted to the given combination device 24 or 25 is deleted there so that it will not continue to be available once the authorization to use has been withdrawn. In the event that the two combination devices 24 and 25 do not have a communications link with one another at all times, a mutual checking or adjustment of the authorization or non-authorization to use the sets of digital data D1, D2, D1′ and D2′ may take place whenever communication is possible between the combination devices.

Both the first combination device 24 and the second combination device 25 have combined processing means 16, 22. The management means 9 are superior to the combined processing means 16, 22, the checking means 15, 21 and the blocking means 18 in the hierarchical arrangement and are implemented in the form of software, so that no infringement of rights of use can occur in either of the two combination devices 24 and 25.

Given the form taken by the data-sink device 3 and the data-source device, the combination devices 24 and 25 have both first communications means 12 and second communications means 23, which are shown separately from one another in FIG. 2. It will however be appreciated by those skilled in the art that the communications means may also be implemented together in one unit.

It should be mentioned that provision may also be made in a solution in accordance with the invention for the owner data OD and the authorization-to-use data UGD to be combined in such a way that the sets of decoding information DC1 and DC1 only have to exist once and no copy is required for generating the authorization-to-use information BBI1 or BBI2. In a solution of this kind, the withdrawal of the particular decoding information DC1 or DC2 for the data-source device 4 is, for example, achieved by storing the data-sink information SO as the blocking information BL1 or BL2. With the help of the management means 9, it can then be ensured that as soon as valid blocking information BL1 or BL2 exists, the data-source device 4 can no longer access the decoding information DC1 or DC2. In a similar way, the transfer back of the rights to use the sets of digital data D1 and D2 can be achieved by overwriting the data-sink information SO that is stored as blocking information BL1 or BL2 with the owner information OI1 or OI2. In this case too it can be unequivocally established who the actual owner of the sets of digital data D1 and D2 is, because the owner information OI1 or OI2 is never changed and the blocking information for the data-sink device continues to have the same significance. In this connection, it should be mentioned that the transfer back of the rights to use the sets of digital data D1 and D2 may also be effected by simply deleting the data-sink information SO that is stored as blocking information BL1 or BL2, so that all that are now retained are the decoding information DC1 and the owner information OI1 if the data-source device 4 is to be given an authorization to use the sets of digital data D1 and D2. The same is also true of the embodiment shown in FIG. 2.

It should be mentioned at this point that it is also possible for a data-source device 4 to be provided without a data-sink device 3, though with the device 2. Similarly, it should be mentioned that it is also possible for a data-sink device 3 to be provided without a data-source device 4, though with the device 2.

It should be mentioned that availability of the authorization-to-use information or decoding information may also be granted with a limitation only in respect of time, in which case an interested party, who, for example, wishes to borrow and watch data representing a film, requests the authorization to do so, and this authorization is then granted but remains available only for as long as the interested party is actually looking at the film, so that the authorization is automatically withdrawn again, i.e. is returned and deleted, once the film ends. Hence the authorization is only available to the interested party, i.e. the borrower and viewer of the film, temporarily.

It should be mentioned that it is also possible for the data-sink information SO and/or the data-source information SI to be present temporarily in the particular processing devices 3 or 4, as for example is the case when one of the two users 6 or 7 identifies himself to the particular processing device 3 or 4 by means of what is termed a chip card, in which user information clearly identifying the user is stored, and the processing device 3 or 4 uses the user information make available with the help of the chip card either as data-sink information SO or data-sink information SI for as long as the chip card is accessible to it by means of, for example, a so-called reader.

It should be mentioned that, even though only a single data-source device 4 and a single data-sink device 3 are shown in FIG. 1, there could equally well be a plurality of data-source devices 4, 4′, 4″, etc. and/or a plurality of data-sink devices 3, 3′, 3″, etc., the authorization to use the sets of digital data supplied by the individual data-source devices 4, 4′, 4″, etc. to the data-sink devices 3, 3′, 3″, etc. being managed by means of the device 2 and particularly by means of the management means 9.

It should also be mentioned that the sets of digital data D1 and D2 may represent information of various types, such as, for example, audio information or video information, or a combination of the two, or textual information, such as books or document, for example, or even combinations of the types of information just mentioned. It should in addition be mentioned that there may of course be more than two sets of digital data D1 and D2.

It should further be mentioned that in the communications system 1 shown in FIG. 1, the communication between the device 2 and the data-source device 4 or data-sink device 3, and in the system shown in FIG. 2 the communication between the two combination devices 24 and 25, may also take place in a contactless manner, such as via a radio link, for example.

It should be mentioned that the device 2 and/or the data-sink device 3 and/or the data-source device 4 may also be implemented by means of personal computers. It should further be mentioned that the device 2 too may take the form of a networkable audio recording and/or reproducing device, such as, for example, an MP3 player/recorder, or a networkable video recording and/or reproducing device such as, for example, a video recorder.

1. A method for preventing unwanted use of digital data (D1, D2; D1′ D2′), which digital data (D1, D2; D1′ D2′) is available in encoded form, which digital data (D1, D2; D1′ D2′) is made accessible by a data-source device (4) to a data-sink device (3) and which digital data (D1, D2; D1′ D2′) has associated with it blocking information (BL1, BL2; BL1′, BL2′) by means of which any making available of the digital data (D1, D2; D1′ D2′) by the data-sink device (3) to a further data-sink device can be blocked, which method comprises the method steps specified below, namely, making available of authorization-to-use information (BBI1, BBI2; BBI1′, BBI2′) to a data-sink device (3), which authorization-to-use information (BBI1, BBI2; BBI1′, BBI2′) is made available separately from the digital data (D1, D2; D1′ D2′), is intended for authorizing the use of the digital data (D1, D2; D1′ D2′) by the data-sink device (3) and comprises at least the blocking information (BL1, BL2; BL1′, BL2′) plus decoding information (DC1, DC2; DC1′ DC2′), which decoding information (DC1, DC2; DC1′ DC2′) is associated with the digital data (D1, D2; D1′ D2′), with which decoding information (DC1, DC2; DC1′ DC2′) the digital data (D1, D2; D1′ D2′) can be decoded, and which decoding information (DC1, DC2; DC1′ DC2′) is available to the data-source device (4) before the authorization-to-use information (BBI1, BBI2; BBI1′, BBI2′) is made available to the data-sink device (3), and withdrawal of the availability of the decoding information (DC1, DC2; DC1′ DC2′) to the data-source device (4).

2. A method as claimed in claim 1, wherein the withdrawal of the availability of the decoding information (DC1, DC2; DC1′ DC2′) to the data-source device (4) is performed by deleting the decoding information (DC1, DC2; DC1′ DC2′) available to the data-source device (3).

3. A method as claimed in claim 1, wherein note is also taken of data-sink information (SO) by means of which the data-sink device (3) can be identified.

4. A method as claimed in claim 1, wherein the making available of the authorization-to-use information (BBI1, BBI2; BBI1′, BBI2′) to the data-sink device (3) and the withdrawal of the availability of the decoding information (DC1, DC2; DC1′, DC2′) to the data-source device (4) is able to be instigated, as a function of first relationship information (RI1) by means of which the relationship between a user (7) of the data-source device (4) and a user (6) of the data-sink device (3) can be defined, either only by the user (7) of the data-source device (4) or by the user (6) of the data-sink device (3) as well.

5. A method as claimed in claim 1, wherein termination of the making available of the digital data (D1, D2; D1′ D2′) to the data-sink device (3) comprises firstly the making available to the data-source device (4) of the decoding information (DC1, DC2; DC1′ DC2′) that was previously made available to the data-sink device (3) and secondly the withdrawal of the availability of the decoding information (DC1, DC2; DC1′ DC2′) to the data-sink device (3).

6. A method as claimed in claim 5, wherein the termination of the availability of the digital data (D1, D2; D1′ D2′) to a data-sink device (3) is performed, as a function of second relationship information (RI2) by means of which a relationship between a user (7) of the data-source device (4) and a user (6) of the data-sink device (3) can be defined, either only by the user (6) of the data-sink device (3) or by the user (7) of the data-source device (4) as well.

7. A device (2) for preventing unwanted use of digital data (D1, D2; D1′ D2′), which digital data (D1, D2; D1′ D2′) is available in encoded form, which digital data (D1, D2; D1′ D2′) can be made accessible by a data-source device (4) to a data-sink device (3) and which digital data (D1, D2; D1′ D2′) has associated with it blocking information (BL1, BL2; BL1′, BL2′) by means of which any making available of the digital data (D1, D2; D1′ D2′) by the data-sink device (3) to a further data-sink device can be blocked, wherein management means (9) are provided, which management means (9) are arranged to make available authorization-to-use information (BBI1, BBI2; BBI1′, BBI2′) to a data-sink device (3), which authorization-to-use information (BBI1, BBI2; BBI1′, BBI2′) exists separately from the digital data (D1, D2; D1′ D2′), is intended for authorizing the use of the digital data (D1, D2; D1′ D2′) by the data-sink device (3) and comprises at least the blocking information (BL1, BL2; BL1′, BL2′) plus decoding information (DC1, DC2; DC1′DC2′), which decoding information (DC1, DC2; DC1′ DC2′) is associated with the digital data (D1, D2; D1′ D2′), with which decoding information (DC1, DC2; DC1′ DC2′) the digital data (D1, D2; D1′ D2′) can be decoded, and which decoding information (DC1, DC2; DC1′ DC2′) is available to the data-source device (4) before the authorization-to-use information (BBI1, BBI2; BBI1′, BBI2′) is made available to the data-sink device (3), and wherein the management means (9) are arranged to withdraw the availability of the decoding information (DC1, DC2; DC1′ DC2′) to the data-source device (4).

8. A device (2) as claimed in claim 7, wherein, for withdrawing the availability of the decoding information (DC1, DC2; DC1′ DC2′) to the data-source device (4), the management means (9) are arranged to delete the decoding information (DC1, DC2; DC1′ DC2′) available to the data-source device (4).

9. A device (2) as claimed in claim 7, wherein the management means (9) are, in addition, arranged to take note of data-sink information (SO) for the data-source device (4) by means of which the data-sink device (3) can be identified.

10. A device (2) as claimed in claim 7, wherein the management means (9) are, in addition, arranged to take account of first relationship information (RI1) by means of which a relationship between a user (7) of the data-source device (4) and a user of the data-sink device (3) can be defined, and wherein the management means (9) are arranged, as a function of the relationship defined by the first relationship information (RI1), to enable the making available of the authorization-to-use information (BBI1, BBI2; BBI1′, BBI2′) to the data-sink device (3) and the withdrawal of the availability of the decoding information (DC1, DC2; DC1′ DC2′) to the data-source device (4) to take place either only at the instigation of the user (7) of the data-source device (4) or at the instigation of the user (6) of the data-sink device (3) as well.

11. A device (2) as claimed in claim 7, wherein, for termination of the availability of the digital data (D1, D2; D1′ D2′) to the data-sink device (3), the management means (9) are arranged to make available to the data-source device (4) the decoding information (DC1, DC2; DC1′ DC2′) that was previously made available to the data-sink device (3) and to withdraw the availability of the decoding information (DC1, DC2; DC1′ DC2′) to the data-sink device (3).

12. A device (2) as claimed in claim 11, wherein the management means (9) are, in addition, arranged to take account of second relationship information (RI2) by means of which a relationship between a user (7) of the data-source device (4) and a user (6) of the data-sink device (3) can be defined, and wherein the management means (9) are arranged, as a function of the relationship defined by the second relationship information (RI2), to enable the termination of the availability of the digital data (D1, D2; D1′ D2′) to the data-sink device (3) to take place either only at the instigation of the user (6) of the data-sink device (3) or at the instigation of the user (7) of the data-source device (4) as well.

13. A data-sink device (3) for using digital data, which digital data (D1, D2; D1′ D2′) is available in encoded form, which digital data (D1, D2; D1′D2′) can be made accessible by a data-source device (4) to the data-sink device (3) and which digital data (D1, D2; D1′D2′) has associated with it blocking information (BL1, BL2; BL1′, BL2′) by means of which any making available of the digital data (D1, D2; D1′ D2′) by the data-sink device (3) to a further data-sink device can be blocked, wherein first processing means (16) are provided that are arranged to process the digital data (D1, D2; D1′ D2′) by taking account of a first enabling signal (ES1) able to be fed to them, which first enabling signal (ES1) enables the digital data (D1, D2; D1′ D2′) to be processed by the first processing means, and by using decoding information (DC1, DC2; DC1′ DC2′), which decoding information (DC1, DC2; DC1′ DC2′) is associated with the digital data (D1, D2; D1′ D2′) and the digital data (D1, D2; D1′ D2′) can be decoded by means thereof, wherein first checking means (15) are provided that are arranged firstly to cooperate with a device (2) as claimed in any of claims 7 to 12, that are arranged secondly to check whether authorization-to-use information (BBI1, BBI2; BBI1′, BBI2′) is available for the data-sink device (3), which authorization-to-use information (BBI1, BBI2; BBI1′, BBI2′) exists separately from the digital data (D1, D2; D1′ D2′), is intended for authorizing the use of the digital data (D1, D2; D1′ D2′) by the data-sink device (3), comprises at least the blocking information (BL1, BL2; BL1′, BL2′) and the decoding information (DC1, DC2; DC1′ DC2′) and is available to the data-source device (4) before it is made available to the data-sink device (3), and that are arranged thirdly to generate the first enabling signal (ES1) and transmit the first enabling signal (ES1) to the processing means (16) when there is a positive result to the check, and wherein first blocking means (18) are provided that, by taking account of the blocking information (BL1, BL2; BL1′, BL2′), are arranged to block any making available of the digital data (D1, D2; D1′ D2′) to a further data-sink device.

14. A data-sink device (3) as claimed in claim 13, which data-sink device (3) contains a device (2) as claimed in any of claims 7 to 12.

15. A data-source device (4) for making digital data (D1, D2; D1′ D2′) available to a data-sink device (3), which digital data (D1, D2; D1′ D2′) is available in encoded form and which digital data (D1, D2; D1′ D2′) has associated with it blocking information (BL1, BL2; BL1′, BL2′) by means of which any making available of the digital data (D1, D2; D1′ D2′) by the data-sink device (3) to a further data-sink device (3) can be blocked, wherein second processing means (22) are provided that are arranged to process the digital data (D1, D2; D1′ D2′) by taking account of a second enabling signal (ES2) able to be fed to them, which second enabling signal (ES2) enables the digital data (D1, D2; D1′ D2′) to be processed by. the second processing means (22), and by using decoding information (DC1, DC2; DC1′ DC2′), which decoding information (DC1, DC2; DC1′ DC2′) is associated with the digital data (D1, D2; D1′D2′) and the digital data (D1, D2; D1′ D2′) can be decoded by means thereof, and wherein second checking means (21) are provided that are arranged firstly to cooperate with a device (2) as claimed in any of claims 7 to 12, that are arranged secondly to check whether decoding information (DC1, DC2; DC1′ DC2′) is available for the data-source device (4), and that are arranged thirdly to generate the second enabling signal (ES2) and transmit the second enabling signal (ES2) to the second processing means (22) when there is a positive result to the check.

16. A data-source device (4) as claimed in claim 15, which data-source device (4) contains a device (2) as claimed in any of claims 7 to 12.

17. A combination device (24, 25) having a data-source device and a data-sink device, which combination device (24, 25) contains a data-source device (4) as claimed in either of claims 13 and 14 and a data-sink device (3) as claimed in either of claims 15 and 16.
